(19) United States
(12) Patent Application Publication
(10) Pub. No.: US 2026/0066931 A1
(43) Pub. Date: Mar. 5, 2026

(54) RADIO FREQUENCY FRONT END ARCHITECTURE

(71) Applicant: Cisco Technology, Inc., San Jose, CA (US)

(72) Inventors: Sivadeep R. KALAVAKURU, Pleasanton, CA (US); Xiangxiang FANG, Campbell, CA (US)

(21) Appl. No.: 18/821,606

(22) Filed: Aug. 30, 2024

(51) Int. Cl. H04B 1/16; H04B 1/04

(52) U.S. Cl. CPC H04B 1/16; H04B 1/04; H04B 2001/0425

(57) ABSTRACT

The present disclosure describes an access point that filters the input to power amplifiers of a front end module. The access point includes a transmitter, a bandpass filter, a non-linear power amplifier, and an antenna. The transmitter produces an electrical signal. The bandpass filter filters the electrical signal from the transmitter to produce a filtered signal. The non-linear power amplifier amplifies the filtered signal from the bandpass filter to produce an amplified signal. The antenna transmits a first wireless signal based on the amplified signal.

### TECHNICAL FIELD

Embodiments presented in this disclosure generally relate to wireless communications. More specifically, embodiments disclosed herein relate to a radio frequency front end architecture (e.g., for an access point).

### BACKGROUND

Access points provide wireless access to network deployments. The access points include radios with front end modules that prepare or adjust electrical signals from a transmitter before directing the electrical signals to an antenna. When radios operate simultaneously in the same band, the radios may interfere with each other (which may be referred to as coexistence problems). Existing front end modules include multiple switchable bandpass filters that filter signals output from the power amplifiers of the front end module. These filters remove non-linearity from these outputs, which reduces radio frequency leakage among the radios and interference between the radios. These bandpass filters, however, need to operate at a high operating point, which results in high power consumption, high insertion loss, poor direct current (DC)/thermal efficiency, and poor performance.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1A illustrates an example system.

FIG. 1B illustrates an example access point in the system of FIG. 1A.

FIG. 2 illustrates an example radio in the access point of FIG. 1B.

FIGS. 3A through 3C illustrate example signals in the access point of FIG. 1B.

FIG. 4 is a flowchart of an example method performed by the system of FIG. 1A.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

The present disclosure describes an access point that filters the input to power amplifiers of a front end module. According to an embodiment, an access point includes a transmitter, a bandpass filter, a non-linear power amplifier, and an antenna. The transmitter produces an electrical signal. The bandpass filter filters the electrical signal from the transmitter to produce a filtered signal. The non-linear power amplifier amplifies the filtered signal from the bandpass filter to produce an amplified signal. The antenna transmits a first wireless signal based on the amplified signal.

According to another embodiment, a method includes producing, by a transmitter, an electrical signal and filtering, by a bandpass filter, the electrical signal from the transmitter to produce a filtered signal. The method also includes amplifying, by a non-linear power amplifier, the filtered signal from the bandpass filter to produce an amplified signal and transmitting, by an antenna, a first wireless signal based on the amplified signal.

According to another embodiment, an access point includes an integrated circuit and a front end module. The integrated circuit produces an electrical signal. The front end module includes a bandpass filter, a non-linear power amplifier, and an antenna. The bandpass filter filters the electrical signal from the integrated circuit to produce a filtered signal. The non-linear power amplifier amplifies the filtered signal from the bandpass filter to produce an amplified signal. The antenna transmits a first wireless signal based on the amplified signal.

### EXAMPLE EMBODIMENTS

The present disclosure describes an access point that filters the input to a non-linear power amplifier of a front end module to avoid using bandpass filters to filter the outputs of the non-linear power amplifier. Generally, the access point includes a bandpass filter that filters an electrical signal from a transmitter. The bandpass filter may reduce the non-linearity of the electrical signal from the transmitter. The filtered signal is then directed to a non-linear power amplifier of the front end module. The power amplifier may operate at a high biasing condition, which may reduce out-of-band harmonics and the non-linearity of the power amplifier. In this manner, the front end module reduces non-linearity without using a filter on the output of the power amplifier.

In certain embodiments, the access point provides several technical advantages. For example, the access point reduces power consumption relative to existing access points that include filters that filter the outputs of the power amplifiers of the front end modules. Additionally, the access point provides improved DC/thermal efficiency and improved radio performance.

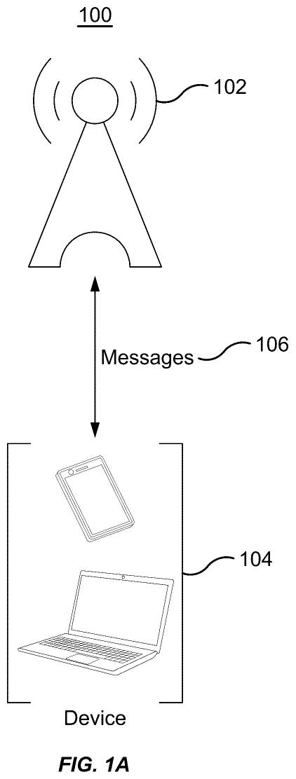

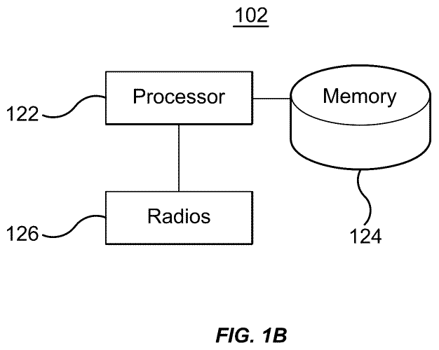

FIG. 1A illustrates an example system 100, which may be a network deployment that provides wireless communication (e.g., wireless fidelity (Wi-Fi) communications). As seen in FIG. 1A, the system 100 includes an access point 102 and one or more devices 104.

The access point 102 facilitates wireless communication in the system 100. The device 104 may connect to the access point 102. The access point 102 may then facilitate wireless communication for the device 104. For example, the device 104 may communicate a message or data stream to the access point 102. The access point 102 may route the message or data stream towards its destination. As another example, the access point 102 may receive a message or data stream for the device 104. The access point 102 may direct the message or data stream to the device 104.

The device 104 may be any suitable device that wirelessly connects to the access point 102. As an example and not by way of limitation, the device 104 may be a computer, a laptop, a wireless or cellular telephone, an electronic notebook, a personal digital assistant, a tablet, or any other device capable of receiving, processing, storing, or communicating information with other components of the system 100. The device 104 may be a wearable device such as a virtual reality or augmented reality headset, a smart watch, or smart glasses. The device 104 may also include a user interface, such as a display, a microphone, keypad, or other appropriate terminal equipment usable by the user. The device 104 may include a hardware processor, memory, or circuitry configured to perform any of the functions or actions of the device 104 described herein. For example, a software application designed using software code may be stored in the memory and executed by the processor to perform the functions of the device 104.

The access point 102 includes a radio that communicates messages 106 wirelessly between the access point 102 and the device 104. Generally, the radio includes a transmitter and a receiver. The transmitter generates electrical signals that include data to be communicated using the messages 106. The radio also includes a front end module that includes a bandpass filter that filters the electrical signals from the transmitter to remove non-linearity in the electrical signals. The front end module also includes a non-linear power amplifier that amplifies the output of the bandpass filter. The radio also includes an antenna that generates and transmits the wireless messages 106 based on the output of the non-linear amplifier. Additionally, the antenna may receive wireless messages 106 from the device 104. The antenna may convert the wireless messages 106 into electrical signals. The front end module may process these electrical signals and direct the electrical signals to the receiver in the radio. In this manner, the access point 102 communicates wireless messages with the device 104.

In certain embodiments, by using the bandpass filter to filter the input to the non-linear power amplifier in the radio, the access point 102 reduces power consumption relative to existing access points that include filters that filter the outputs of the power amplifiers of the front end modules. Moreover, the access point 102 provides improved DC/thermal efficiency and improved radio performance.

FIG. 1B illustrates an example access point 102 in the system 100 of FIG. 1A. As seen in FIG. 1B, the access point 102 includes a processor 122, a memory 124, and one or more radios 126.

The processor 122 is any electronic circuitry, including, but not limited to one or a combination of microprocessors, microcontrollers, application specific integrated circuits (ASIC), application specific instruction set processor (ASIP), and/or state machines, that communicatively couples to the memory 124 and controls the operation of the access point 102. The processor 122 may be 8-bit, 16-bit, 32-bit, 64-bit or of any other suitable architecture. The processor 122 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 122 may include other hardware that operates software to control and process information. The processor 122 executes software stored on the memory 124 to perform any of the functions described herein. The processor 122 controls the operation and administration of the access point 102 by processing information (e.g., information received from the memory 124 and radios 126). The processor 122 is not limited to a single processing device and may encompass multiple processing devices contained in the same device or computer or distributed across multiple devices or computers. The processor 122 is considered to perform a set of functions or actions if the multiple processing devices collectively perform the set of functions or actions, even if different processing devices perform different functions or actions in the set.

The memory 124 may store, either permanently or temporarily, data, operational software, or other information for the processor 122. The memory 124 may include any one or a combination of volatile or non-volatile local or remote devices suitable for storing information. For example, the memory 124 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 124, a disk, a CD, or a flash drive. In particular embodiments, the software may include an application executable by the processor 122 to perform one or more of the functions described herein. The memory 124 is not limited to a single memory and may encompass multiple memories contained in the same device or computer or distributed across multiple devices or computers. The memory 124 is considered to store a set of data, operational software, or information if the multiple memories collectively store the set of data, operational software, or information, even if different memories store different portions of the data, operational software, or information in the set.

The radios 126 may communicate messages or information using different communication technologies. For example, the access point 102 may use one or more of the radios 126 for Wi-Fi communications. The access point 102 may use one or more of the radios 126 to transmit messages and one or more of the radios 126 to receive messages. The access point 102 may include any number of radios 126 to communicate using any number of communication technologies.

The access point 102 may include any number of (e.g., one or multiple) processors 122 and memories 124. Generally, one or multiple processors 122 are considered to perform an operation (or configured to perform the operation) if (i) at least one of the processors 122 individually performs every step of the operation or (ii) multiple processors 122 collectively perform the steps of the operation (e.g., if one processor 122 performs the first half of the operation and another processor 122 performs the second half of the operation). Additionally, one or multiple memories 124 are considered to perform an operation (or configured to perform the operation) if (i) at least one of the memories 124 individually performs every step of the operation or (ii) multiple memories 124 collectively perform the steps of the operation (e.g., if one memory 124 performs the first half of the operation and another memory 124 performs the second half of the operation).

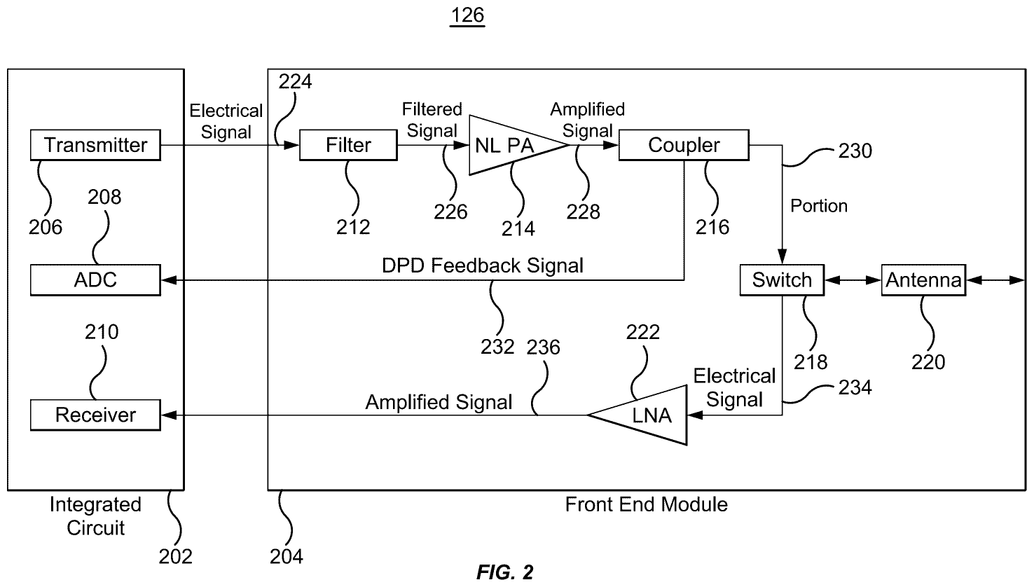

FIG. 2 illustrates an example radio 126 in the access point 102 of FIG. 1B. As seen in FIG. 2, the radio 126 includes an integrated circuit 202 and a front end module 204. The integrated circuit 202 includes a transmitter 206, an analog-to-digital converter 208, and a receiver 210. The front end module 204 includes a filter 212, a non-linear power amplifier 214, a coupler 216, a switch 218, an antenna 220, and a low noise amplifier 222. Generally, the transmitter 206 generates and directs electrical signals to the front end module 204, and the front end module 204 converts the electrical signals into wireless signals for transmission. Additionally, the front end module 204 receives wireless signals and converts the wireless signals into electrical signals for the receiver 210.

As discussed previously, the access point 102 may include multiple radios 126 that are positioned close or proximate each other. As a result, if the signals transmitted by the radios 126 are in overlapping bands or frequencies, then the radios 126 may interfere with each other, degrading performance. Existing access points use radios that include bandpass filters that filter the outputs of the power amplifiers in the radios, which removes non-linearity or distortions in the outputs of the power amplifiers. By removing the non-linearity or distortions, the bandpass filters reduce the likelihood that the radios will interfere with each other. These bandpass filters, however, operate at a high operating point, which results in high power consumption, poor DC/thermal efficiency, and poor performance. Generally, the radio 126 uses the filter 212 to filter the input to the non-linear power amplifier 214. The filter 212 removes non-linearity from the input to the non-linear power amplifier 214. Additionally, the non-linear power amplifier 214 operates at a high biasing condition, which further removes non-linearity or distortions. In this manner, the radio 126 avoids having to use a bandpass filter at the output of the non-linear power amplifier 214, in certain embodiments. Additionally, the radio 126 reduces radio frequency leakage and interference with other radios of the access point.

The transmitter 206 generates an electrical signal 224 using information from the access point (e.g., from the processor 122 shown in FIG. 1B). The information may include data for transmission. The electrical signal 224 may include the data. The transmitter 206 directs the electrical signal 224 to the filter 212 of the front end module 204.

The filter 212 receives the electrical signal 224 from the transmitter 206 and filters the electrical signal 224 to produce a filtered signal 226. Generally, the filter 212 may filter or remove certain frequencies from the electrical signal 224 to produce the filtered signal 226. For example, if the filter 212 is a bandpass filter, then the filter 212 may pass frequencies within a band while attenuating or removing frequencies outside the band. In this manner, the filter 212 may remove non-linearity from the electrical signal 224. In some embodiments, the filter 212 is a bandpass filter with an out of band rejection of at least 39 decibels (dBs) (e.g., approximately 40 dBs), which may reduce the out of band noise floor. The filter 212 reduces non-linearity in the electrical signal 224 from the transmitter 206, and the filter 212 produces the filtered signal 226 that is more linear and in spectrum. The filter 212 directs the filtered signal 226 to the non-linear power amplifier 214.

The non-linear power amplifier 214 amplifies the filtered signal 226 to produce an amplified signal 228. Generally, non-linear power amplifiers may include non-linear active devices (e.g., bipolar transistors, field effect transistors, etc.), which may introduce distortions into the output (e.g., distortions in the amplitude, frequency, and/or phase of the output). In the radio 126, the non-linear power amplifier 214 may operate at a high biasing condition, which may reduce out-of-band harmonics and the non-linearity of the non-linear power amplifier 214. The non-linear power amplifier 214 directs the amplified signal 228 to the coupler 216.

In some embodiments, the non-linear power amplifier 214 has a gain of 32 dBs to 34 dBs with an output power of 24 decibel-milliwatts (dBm). The non-linear power amplifier 214 operates at a high biasing condition with a power backoff that exceeds 10 dBs. By operating the non-linear power amplifier 214 at the high biasing condition with the power backoff that exceeds 10 dBs, out of band harmonics that result from non-linearity of the non-linear power amplifier 214 may be heavily reduced (e.g., down to −117 dBm/megaHertz (MHz)). In this manner, the radio 126 may avoid having to include one or more bandpass filters at the output of the non-linear power amplifier 214, which reduces insertion loss and power consumption and improve DC/thermal efficiency and performance.

In certain embodiments, the non-linear power amplifier 214 is operated using variable biasing. The biasing condition of the non-linear power amplifier 214 may be changed as needed. For example, if interference with neighboring radios is not a concern, then the non-linear power amplifier 214 may be operated in a biasing condition different from the high biasing condition. When interference becomes a concern, then the biasing condition of the non-linear power amplifier 214 may be switched to the high biasing condition. A processor (e.g., the processor 122 shown in FIG. 1B) may adjust the operating point (e.g., biasing condition) of the non-linear power amplifier 214 according to the needs of the access point. For example, when the power of the transmitter 206 or antenna 220 is not high, then there is less concern about interfering with other radios. As a result, the processor may change the operating point of the non-linear power amplifier 214 from the high biasing condition to another biasing condition.

The coupler 216 may be a radio frequency coupler that divides power in the amplified signal 228 to multiple output ports. As seen in FIG. 2, the coupler 216 directs a portion 230 of the amplified signal 228 to the switch 218. The coupler 216 uses a portion of the amplified signal 228 to generate a digital predistortion (DPD) feedback signal 232. The coupler 216 directs the DPD feedback signal 232 to the ADC 208 in the integrated circuit 202. Generally, the DPD feedback signal 232 is a portion of the amplified signal 228 that is fed back to the integrated circuit 202. A processor of the access point (e.g., the processor 122 shown in FIG. 1B) uses the DPD feedback signal 232 to determine the distortion or non-linearity in the output of the non-linear power amplifier 214. The processor then communicates instructions or signals to the integrated circuit to adjust the electrical signal 224 from the transmitter 206 (e.g., to adjust amplitude, frequency, phase, etc.) to reduce the non-linearity or distortions in the amplified signal 228. In this manner, the access point uses the DPD feedback signal 232 to adjust the amplified signal 228 and to further reduce non-linearity and distortion. In some embodiments, the access point uses a fifth order polynomial and a memory depth greater than three to implement the DPD feedback.

The switch 218 switches between communicating signals to the antenna 220 and receiving signals from the antenna 220. In a transmit mode, the switch 218 connects the antenna 220 to the coupler 216 so that the antenna receives the portion 230 of the amplified signal 228 from the coupler 216. In a receive mode, the switch 218 connects the antenna 220 to the low noise amplifier 222 so that the low noise amplifier 222 receives an electrical signal 234 from the antenna 220. Generally, the processor may control the mode of the switch 218.

In the transmit mode, the switch 218 directs the portion 230 of the amplified signal 228 from the coupler 216 to the antenna 220. The antenna 220 converts the portion 230 to a wireless signal and transmits the wireless signal. In the receive mode, the antenna 220 receives a wireless signal and converts the wireless signal into the electrical signal 234. The switch 218 directs the electrical signal 234 from the antenna 220 to the low noise amplifier 222. The low noise amplifier 222 amplifies the electrical signal 234 from the antenna 220 to produce an amplified signal 236. The low noise amplifier 222 then directs the amplified signal 236 to the receiver 210.

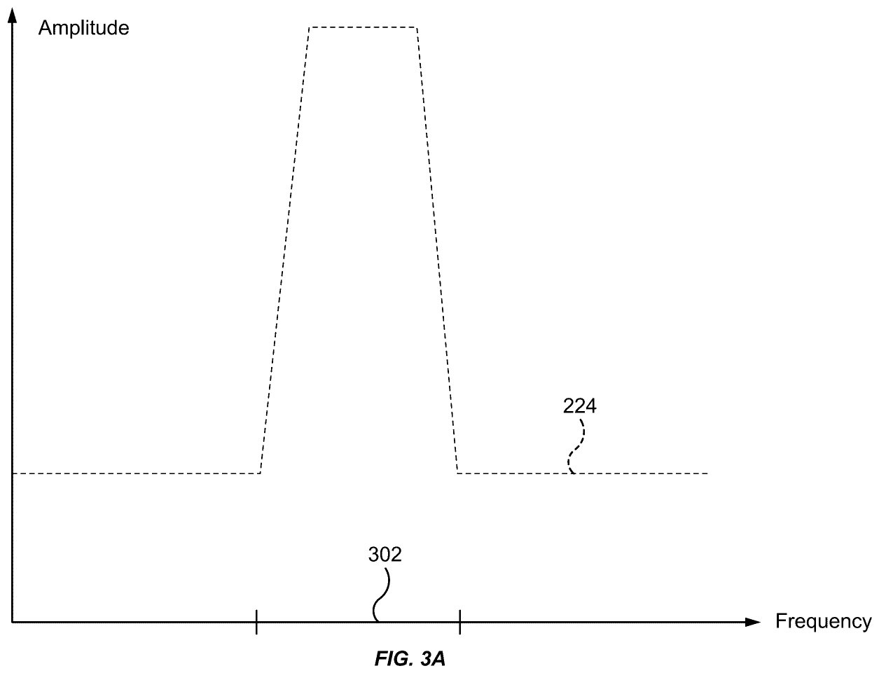

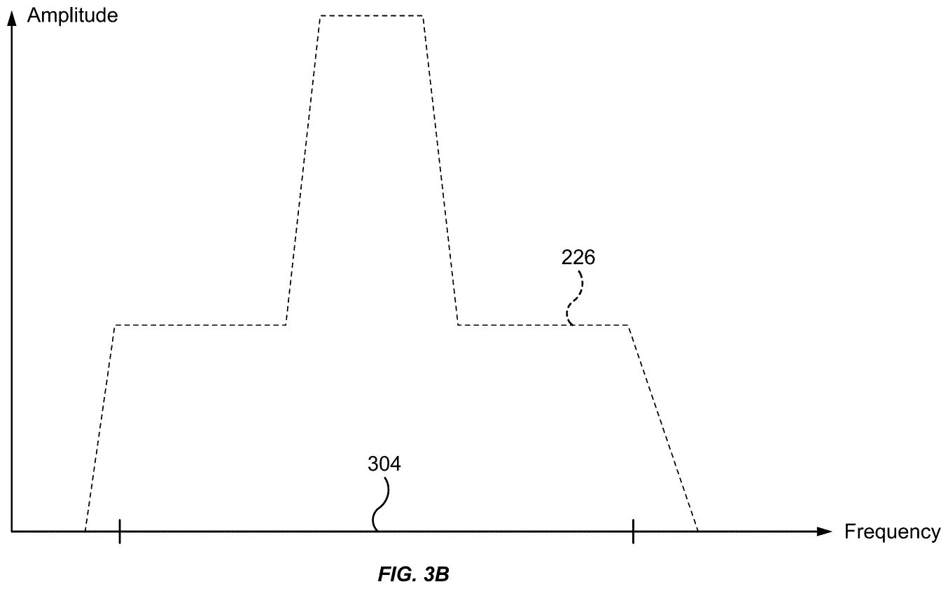

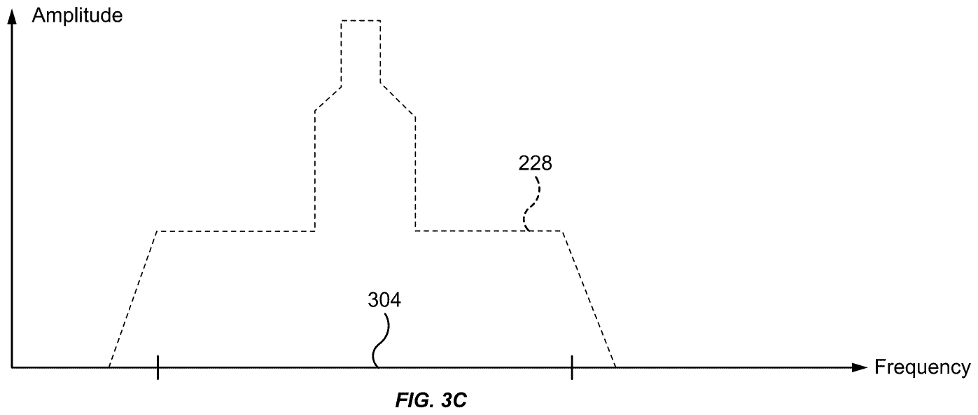

FIGS. 3A through 3C illustrate example signals in the access point 102 of FIG. 1B. FIG. 3A shows an example electrical signal 224 (e.g., input to the filter 212 shown in FIG. 2) in the frequency domain. FIG. 3B shows an example filtered signal 226 (e.g., output from the filter 212 and input to the non-linear power amplifier 214, shown in FIG. 2) in the frequency domain. FIG. 3C shows an example amplified signal 228 (e.g., output from the non-linear power amplifier 214 shown in FIG. 2) in the frequency domain.

As seen in FIG. 3A, the electrical signal 224 includes frequency components that span the frequency domain. The amplitude of the electrical signal 224 is higher for a band 302 of frequencies, indicating that the frequency components that fall in the band 302 have a larger contribution to the electrical signal 224 than frequency components outside the band 302. In some embodiments, the electrical signal 224 has a maximum signal to noise ratio of 55 dB and a bandwidth between 20 MHz and 160 MHz.

As seen in FIG. 3B, the filtered signal 226 resembles the electrical signal 224 within a band 304 of frequencies. The band 304 may be the passband of a bandpass filter (e.g., the filter 212 shown in FIG. 2) that filters the electrical signal 224 shown in FIG. 3A to produce the filtered signal 226. Generally, the bandpass filter passes frequency components that are in the band 304 and attenuates or removes frequency components that are outside the band 304. As seen in FIG. 3B, the filtered signal 226 attenuates quickly outside the band 304, with frequency components further away from the band 304 being completely removed. Frequency components within the band 304 are maintained and included in the filtered signal 226.

As seen in FIG. 3C, the amplified signal 228 resembles the filtered signal 226 within the band 304. The signal to noise ratio of the amplified signal 228 may be less than 55 dBs. Additionally, the power of the amplified signal 228 may be 19 dBm. Moreover, non-linearity in the amplified signal 228 is reduced without filtering the output of the non-linear amplifier. Although some spectral regrowth is seen, the spectral regrowth is limited.

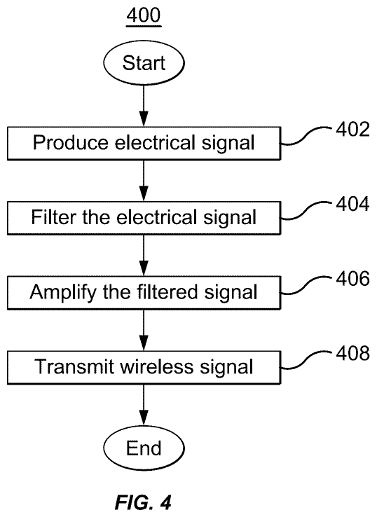

FIG. 4 is a flowchart of an example method 400 performed by the system 100 of FIG. 1A. In certain embodiments, an access point (e.g., the access point 102 shown in FIG. 1) performs the method 400. By performing the method 400, the access point 102 reduces interference amongst the radios of the access point 102 or with other radios of other access points or devices.

In block 402, the access point produces an electrical signal. For example, a transmitter of the access point may produce the electrical signal. The electrical signal may include data or information to be transmitted wirelessly by the access point. In block 404, the access point filters the electrical signal to produce a filtered signal. The access point may use a bandpass filter in a front end module of the access point to filter the electrical signal from the transmitter. The bandpass filter attenuates or removes frequency components of the electrical signal that fall outside a pass band of the bandpass filter. In some embodiments, by filtering the electrical signal, the access point reduces non-linearity in the electrical signal.

In block 406, the access point amplifies the filtered signal to produce an amplified signal. The access point uses a non-linear power amplifier in the front end module to amplify the filtered signal from the bandpass filter. The non-linear power amplifier may operate in a high biasing condition, which reduces the non-linear response of the non-linear power amplifier. In this manner, the amplified signal may include fewer distortions.

In block 408, the access point transmits a wireless signal based on the amplified signal. The non-linear power amplifier may direct the amplified signal towards an antenna of the access point. The antenna may convert the amplified signal (or a portion of the amplified signal) into the wireless signal and transmit the wireless signal. In some instances, the front end module includes a coupler and a switch that direct the amplified signal (or a portion of the amplified signal) from the non-linear power amplifier to the antenna.

In some embodiments, the coupler generates a DPD feedback signal that the access point uses to adjust the electrical signal from the transmitter. The DPD feedback signal may inform the access point of non-linearity in the amplified signal. The access point then adjusts the electrical signal from the transmitter (e.g., change amplitude, frequency, phase, etc.) to reduce the non-linearity in the amplified signal.

The switch may switch the front end module between transmit and receive modes. During the transmit mode, the switch may connect the antenna to the non-linear amplifier and the coupler. During the receive mode, the switch may connect the antenna to a low noise amplifier and a receiver.

In summary, the access point 102 filters the input to a non-linear power amplifier of a front end module to avoid using bandpass filters to filter the outputs of the non-linear power amplifier. Generally, the access point 102 includes a bandpass filter that filters an electrical signal from a transmitter. The bandpass filter may reduce the non-linearity of the electrical signal from the transmitter. The filtered signal is then directed to a non-linear power amplifier of the front end module. The power amplifier may operate at a high biasing condition, which may reduce out-of-band harmonics and the non-linearity of the power amplifier. In this manner, the front end module reduces non-linearity without using a filter on the output of the power amplifier.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system. ” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. An access point comprising:
a transmitter arranged to produce an electrical signal;
a bandpass filter arranged to filter the electrical signal from the transmitter to produce a filtered signal;
a non-linear power amplifier arranged to amplify the filtered signal from the bandpass filter to produce an amplified signal; and
an antenna arranged to transmit a first wireless signal based on the amplified signal.

2. The access point of claim 1, further comprising a radio frequency coupler arranged to produce a digital predistortion feedback signal based on the amplified signal from the non-linear power amplifier.

3. The access point of claim 2, wherein the electrical signal is adjusted based on the digital predistortion feedback signal.

4. The access point of claim 2, wherein the radio frequency coupler is further arranged to communicate a portion of the amplified signal from the non-linear power amplifier to the antenna.

5. The access point of claim 1, wherein the bandpass filter provides out of band rejection of at least 39 decibels.

6. The access point of claim 1, further comprising a processor configured to adjust an operating point of the non-linear power amplifier based on a power of the transmitter.

7. The access point of claim 1, further comprising a switch arranged to switch the antenna to receive a second wireless signal.

8. A method comprising:
producing, by a transmitter, an electrical signal;
filtering, by a bandpass filter, the electrical signal from the transmitter to produce a filtered signal;
amplifying, by a non-linear power amplifier, the filtered signal from the bandpass filter to produce an amplified signal; and
transmitting, by an antenna, a first wireless signal based on the amplified signal.

9. The method of claim 8, further comprising producing, by a radio frequency coupler, a digital predistortion feedback signal based on the amplified signal from the non-linear power amplifier.

10. The method of claim 9, wherein the electrical signal is adjusted based on the digital predistortion feedback signal.

11. The method of claim 9, further comprising communicating, by the radio frequency coupler, a portion of the amplified signal from the non-linear power amplifier to the antenna.

12. The method of claim 8, wherein the bandpass filter provides out of band rejection of at least 39 decibels.

13. The method of claim 8, further comprising adjusting, by a processor, an operating point of the non-linear power amplifier based on a power of the transmitter.

14. The method of claim 8, further comprising switching, by a switch, the antenna to receive a second wireless signal.

15. An access point comprising:
an integrated circuit arranged to produce an electrical signal; and
a front end module comprising:
a bandpass filter arranged to filter the electrical signal from the integrated circuit to produce a filtered signal;
a non-linear power amplifier arranged to amplify the filtered signal from the bandpass filter to produce an amplified signal; and
an antenna arranged to transmit a first wireless signal based on the amplified signal.

16. The access point of claim 15, wherein the front end module further comprises a radio frequency coupler arranged to produce a digital predistortion feedback signal based on the amplified signal from the non-linear power amplifier.

17. The access point of claim 16, wherein the electrical signal is adjusted based on the digital predistortion feedback signal.

18. The access point of claim 16, wherein the radio frequency coupler is further arranged to communicate a portion of the amplified signal from the non-linear power amplifier to the antenna.

19. The access point of claim 15, wherein the bandpass filter provides out of band rejection of at least 39 decibels.

20. The access point of claim 15, further comprising a processor configured to adjust an operating point of the non-linear power amplifier based on a power of the integrated circuit.
